(19) United States
(12) Patent Application Publication
(10) Pub. No.: US 2018/0170383 A1
(43) Pub. Date: Jun. 21, 2018

(54) METHOD FOR CONTROLLING AN ACTUAL SPEED OF A MOTOR VEHICLE

(71) Applicant: SCANIA CV AB, Sodertalje (SE)

(72) Inventors: Oscar FLÄRDH, Älvsjö (SE); Fredrik ROOS, Segeltorp (SE); Erik ENEROTH, Bromma (SE)

(21) Appl. No.: 15/576,517

(22) PCT Filed: May 2, 2016
(86) PCT No.: PCT/SE2016/050384

§ 371 Date: Nov. 22, 2017

(30) Foreign Application Priority Data
Jun. 8, 2015 (SE) 1550744-5

(51) Int. Cl. B60W 30/14; B60W 50/00; B60W 40/076; B60W 40/105; B60W 40/13; B60W 30/188

(52) U.S. Cl. CPC B60W 30/146; B60W 50/0097; B60W 40/076; B60W 40/105; B60W 40/13; B60W 30/1882; B60W 2720/10; B60W 2510/305; B60W 2530/10; B60W 2530/16; B60W 2550/143; B60W 2550/402; B60K 2310/244

(57) ABSTRACT

A method is provided for controlling an actual speed of a motor vehicle. The method comprising the steps of: based on a vehicle configuration of the present vehicle, setting a threshold speed for the vehicle; obtaining a set speed of the vehicle; comparing the set speed to the threshold speed; if the set speed is below the threshold speed; determining a desired reference speed of the vehicle between the set speed and the threshold speed; and adjusting the actual speed of the vehicle toward the reference speed.

### CROSS-REFERENCE TO RELATED APPLICATION(S)

This application is a national stage application (filed under 35 § U.S.C. 371) of PCT/SE2016/050384, filed May 2, 2016 of the same title, which, in turn claims priority to Swedish Application No. 1550744-5, filed Jun. 8, 2015 of the same title; the contents of each of which are hereby incorporated by reference.

### FIELD OF THE INVENTION

The invention relates to a method for controlling an actual speed of a motor vehicle. The invention also relates to a computer program product, an electronic control unit and a motor vehicle.

### BACKGROUND OF THE INVENTION

The cost of fuel for motor vehicles, e.g. cars, trucks and buses, represents a significant expense for the owner or user of the vehicle. In the case of a haulage company, apart from the acquisition cost of a vehicle, the main expenditure items for the routine operation of the vehicle are the driver's salary, repair and maintenance costs, and the cost of fuel for the vehicle's propulsion. The fuel cost may to a large extent impact the company's profitability. A wide variety of different systems have therefore been developed for reducing fuel consumption, e.g. fuel-efficient engines and fuel-economising cruise controls.

A driver of a motor vehicle with a cruise control usually selects a set speed v_set. The set speed v_set is the speed which the driver wishes the motor vehicle to maintain on a level road. The cruise control then provides the engine system in the vehicle with a reference speed v_ref, where the reference speed v_ref is used to control the engine. The set speed v_set may thus be seen as an input signal to the cruise control, while the reference speed v_ref may be seen as an output signal from the cruise control, which is used to control the engine, providing control of the vehicle's actual speed v_actual.

Traditional cruise controls (CC) maintain a constant reference speed v_ref, which corresponds to the set speed v_set requested by the driver. The value of the reference speed v_ref is here changed only when the user himself adjusts the set speed v_set while driving.

Today there are also cruise controls, so-called economical cruise controls, such as Ecocruise controls and similar cruise controls, which try to estimate the current driving resistance and also have knowledge about the historical driving resistance. An experienced driver who drives a motor vehicle without a cruise control may reduce fuel consumption by adjusting the driving to the characteristics of the road ahead, so that unnecessary braking and/or fuel-consuming acceleration may be avoided. In a further development of these economical cruise controls, the ambition is to mimic the experienced driver's adjustment of driving the motor vehicle based on knowledge about the road ahead, so that fuel consumption may be kept at a level as low as possible.

One example of such a further development of an economical cruise control is a “Look Ahead” cruise control (LACC), i.e. a strategic cruise control using knowledge about road sections ahead, i.e. knowledge about the appearance of the road ahead, in order to determine the appearance of the reference speed v_ref. Here, the reference speed v_ref is thus permitted, within a speed interval v_min−v_max, to differ from the set speed v_set selected by the driver in order to achieve a more fuel-efficient driving. For example, by taking topographic information about the road section ahead of the vehicle into account, the speed may be temporarily increased before e.g. an uphill slope, so that downshifting to a lower transmission mode can be avoided or delayed. In this way, fuel consumption can be reduced. Also information about road curvature and legal speed limits along the road section ahead of the vehicle can be taken into account.

WO2014/148973 discloses such a method for controlling the actual speed of a vehicle wherein also a legal speed limit set by an authority is taken into account as the reference speed v_ref is determined. The reference speed v_ref may thus be set to vary within a speed interval v_min−v_max as long as v_max does not exceed the legal speed limit.

However, the total energy consumption of a motor vehicle depends on both external factors such as topography and road appearance, and internal factors such as friction in the power train of the vehicle, power losses of auxiliary systems of the vehicle and of possible electric motors of the vehicle, etc. The total energy consumption is therefore largely dependent on vehicle configuration and vehicle mass. In particular for heavy vehicles such as trucks, the vehicle mass may vary significantly depending on the current load carried by the truck. To reduce the total energy consumption of a vehicle, it may therefore be insufficient to take only external factors such as topography and road appearance into account.

### SUMMARY OF THE INVENTION

It is a primary objective of the present invention to achieve an, in at least some aspect, improved way of controlling the actual speed of a motor vehicle. In particular, it is an objective to achieve a method for controlling the actual speed of a motor vehicle in such a way that the total energy consumption of the vehicle is minimized, without severely affecting the amount of time that it takes to drive a certain distance, or a predetermined route.

According to a first aspect of the present invention, at least the primary objective is achieved by means of the method initially defined, which is characterised in that it comprises the steps:
based on a vehicle configuration and a vehicle mass of the present vehicle, setting a threshold speed v_threshold for the vehicle;
obtaining a set speed v_set of the vehicle;
comparing the set speed v_set to the threshold speed v_threshold;
if the set speed v_set is below the threshold speed v_threshold; determining a desired reference speed v_ref of the vehicle between the set speed v_set and the threshold speed v_threshold; and
adjusting the actual speed of the vehicle toward the reference speed v_ref.

The method according to the present invention enables reduction of the total energy consumption of the vehicle along a travelling route of the vehicle. According to the invention, a threshold speed v_threshold is defined and set for the present vehicle, depending on the vehicle configuration and the vehicle mass. Below the threshold speed, it should generally, but not necessarily, be possible to achieve a reduced energy consumption by increasing the speed of the vehicle, either by upshifting to a higher transmission mode of the vehicle or by simply approaching a speed which is more energy efficient for the particular vehicle as measured in energy consumption per travelled kilometer. In this way, a relatively small speed increase within a predefined speed range can give immediate energy savings and thereby result in a total reduction in energy consumption along the travelled route.

The method also enables potential energy savings further ahead along the travelling route, without having to compromise the total travelling time. At relatively low speeds, it is relatively cheap, from an energy consumption point of view, to increase the speed of the vehicle and thereby gain time. As discussed above, it may even be advantageous from an energy point of view to increase the speed. At road sections where it is necessary to maintain a relatively low speed below the threshold speed v_threshold, the reference speed v_ref can be set to a slightly higher value than the set speed v_set, even if this results momentarily in a slightly increased fuel consumption, depending on how the threshold speed v_threshold is defined. The small speed increase allows the driver to gain time at a relatively low cost of energy. This time can later on be exploited for a small speed reduction at a high-speed road section, such as by reducing the speed to 85 km/h from 90 km/h. Normally, reducing the speed from a relatively high speed results in relatively large energy savings, compared to speed reductions at lower speeds. Travelling time and energy consumption can in this way be optimized.

The threshold speed can e.g. be determined by calculation or estimation and can be based on vehicle parameters such as engine size and type, engine efficiency, mass of the vehicle, number of vehicle axles, front area of the vehicle, drag coefficient, transmission friction, power demand of auxiliary systems such as an AC-compressor, an air compressor, or a generator, road incline, etc., and also e.g. on a gear changing scheme of the vehicle.

According to one embodiment of the invention, an allowed speed range having a lower limit v_min and an upper limit v_max is defined, and the reference speed v_ref is determined so that v_min≤v_ref≤v_max. The step of determining the reference speed may be iterated in order to reach a reference speed v_ref within the allowed speed range. The lower limit v_min of the allowed speed range can preferably be given by the set speed v_set, v_min=v_set. The upper limit v_max of the allowed speed range can be determined in different ways and may e.g. be set to, or related to, a legal speed limit set by an authority, or it can be set in relation to the set speed v_set, such as v_max=1.05*v_set, or v_max=v_set+5 km/h. The upper limit v_max can also be given by an external algorithm, which can be driver specific and set by e.g. a tacography card of the driver. If the upper limit v_max is related to a legal speed limit set by an authority, the information about the speed limit may be collected by means of e.g. optical reading of road signs, by use of traffic information transmitters, GPS-based techniques, or by any other technique known in the art. The upper limit v_max may also be based on e.g. the curvature of the road ahead, in which case v_max may be calculated from a maximum allowed side acceleration or similar. Similarly, the set speed v_set may be related to a legal speed limit or other external factors, such as road curvature, and the upper limit v_max is set in relation to the set speed v_set as described above.

According to one embodiment of the invention, the reference speed v_ref is determined as a function of the set speed v_set. The reference speed v_ref may e.g. be determined as a linear function of v_set, v_ref=k*v_set, wherein k is a constant having a typical value 1<k≤1.15, such as k=1.05. A set speed v_set of 30 km/h will for k=1.05 result in a reference speed v_ref of 31.5 km/h. An advantage of setting the reference speed v_ref as a function of the set speed v_set is that it can be tailored for the particular vehicle configuration and for the vehicle specific relation between the vehicle speed and the energy consumption of the vehicle. The reference speed v_ref may also be determined as a fixed offset so that v_ref=v_set+Δv, wherein Δv can be e.g. maximum 5 km/h. The reference speed may also be set so as to equal an upper speed limit v_max of an allowable speed range as discussed above.

According to one embodiment of the invention, the reference speed v_ref is determined in dependence on external conditions. Such external conditions may be e.g. the current traffic situation or information about the road section ahead of the vehicle with regard to e.g. topographic data. Taking such external data into account may give a more accurate determination of the reference speed v_ref. Preferably, the reference speed v_ref is in this case determined taking both the requested speed v_set and such external conditions into account.

According to one embodiment of the invention, the step of setting the threshold speed v_threshold comprises determining an energy consumption E per travelled kilometer of the vehicle as a function of vehicle speed, and based thereon setting the threshold speed v_threshold. In this way, an accurate determination of the threshold speed v_threshold with the purpose of minimizing the total energy consumption of the particular vehicle can be conducted. The energy consumption E of the vehicle per travelled kilometer is strongly dependent on vehicle configuration. For low speeds, the energy consumption per travelled kilometer is relatively high due to the power losses in auxiliary units, such as cooling systems etc., and power losses in the power train, especially in the engine. For each vehicle configuration and mass, there is an “optimum speed” at which the energy consumption per travelled kilometer is minimized. Above this optimum speed, the total energy consumption increases, mainly due to increased air resistance. The threshold speed v_threshold can be set to this optimum speed or to a value close to the optimum speed. Preferably, the threshold speed v_threshold is set so that an increase in actual speed below the threshold speed v_threshold generally results in a reduced total energy consumption per travelled kilometer. Of course, slight deviations may occur. The energy consumption E per travelled kilometer can e.g. be calculated or estimated based on models, which models may be adapted during the vehicle's lifetime.

According to one embodiment of the invention, said threshold speed is set so that, at the threshold speed v_threshold, the determined energy consumption E per travelled kilometer of the vehicle is within a desired energy consumption range. This gives good control over the energy consumption E of the vehicle. The desired energy consumption range is preferably set to include an optimum energy consumption E_min, which corresponds to the lowest possible energy consumption E per travelled kilometer for the particular vehicle configuration. For example, the energy consumption range may be set to E_min≤E≤E_min+ΔE, wherein ΔE is a fixed value or a function of E_min.

According to one embodiment of the invention, determining the energy consumption E per travelled kilometer of the vehicle as a function of vehicle speed comprises determining power losses relating to at least an air resistance of the vehicle. Since the air resistance increases with the square of the speed of the vehicle, it is the dominating source for power losses at high speeds. Power losses relating to the air resistance may, for many purposes, be sufficient to set a sufficiently accurate value of the threshold speed v_threshold. Such power losses are typically minimized as the vehicle is driven at a constant speed, while as frequent speed increases and speed reductions tend to increase such power losses.

According to one embodiment of the invention, determining the energy consumption E per travelled kilometer of the vehicle as a function of vehicle speed further comprises determining power losses relating to at least one of roll resistance, friction in a power train of the vehicle, auxiliary systems of the vehicle, and/or an electric motor of the vehicle. Taking such power losses into account increases the accuracy of the determination of the energy consumption E, and thereby also of the threshold speed v_threshold.

According to one embodiment of the invention, the step of setting the threshold speed v_threshold is carried out at least following a detection of a change in vehicle mass. The vehicle mass is a main factor affecting the total energy consumption E per travelled kilometer of the vehicle, and it may thereby also affect the optimum threshold speed v_threshold. In particular for a heavy vehicle such as a truck, for which the vehicle mass may vary significantly depending on the load of the vehicle, this is thereby useful. A change in vehicle mass is typically detected by a mass estimation algorithm based on either information from a suspension of the vehicle or on the measured or estimated moment of inertia of the vehicle.

According to one embodiment of the invention, the step of determining a desired reference speed v_ref comprises:
given the actual vehicle speed, determining a lowest possible vehicle speed increase for which a shift to a higher transmission mode of the vehicle is possible; and
based on said determination, setting the reference speed v_ref.

An upshift to a higher transmission mode normally results in a decreased energy consumption E per travelled kilometer, given that the current speed can be maintained and that the vehicle is travelling on a flat road. The reference speed v_ref can therefore be set to a speed enabling an upshift.

According to one embodiment of the invention, the reference speed v_ref is set to the determined lowest possible speed for which a shift to a higher transmission mode of the vehicle is possible. This is a straightforward way to set the reference speed v_ref in order to achieve a reduced energy consumption.

According to one embodiment of the invention, the step of adjusting the actual speed to the reference speed v_ref is conducted automatically using a cruise control of the vehicle. Alternatively, the determined reference speed v_ref may be presented to the driver of the vehicle, who manually adjusts the actual speed of the vehicle to the reference speed v_ref.

According to another aspect of the invention, at least the primary objective is achieved by a computer program comprising computer program code for causing a computer to implement the proposed method when the computer program is executed in the computer.

According to a further aspect of the invention, at least the primary objective is achieved by a computer program product comprising a non-transitory data storage medium which can be read by a computer and on which the program code of the proposed computer program is stored.

According to a further aspect of the invention, at least the primary objective is achieved by an electronic control unit of a motor vehicle comprising an execution means, a memory connected to the execution means and a data storage medium which is connected to the execution means and on which the computer program code of the proposed computer program is stored.

According to a further aspect of the invention, at least the primary objective is achieved by a motor vehicle comprising the proposed electronic control unit.

Other advantageous features as well as advantages of the present invention will appear from the following description.

### BRIEF DESCRIPTION OF THE DRAWINGS

Embodiments of the invention will in the following be described with reference to the appended drawings, in which:

FIG. 1 shows total energy consumption E of a vehicle as a function of vehicle speed,

FIG. 2 is a flow chart showing a method according to the invention,

FIG. 3 shows an exemplary speed curve of a vehicle,

FIG. 4 schematically shows a control unit according to the invention, and

FIG. 5 schematically shows a vehicle according to the invention.

### DETAILED DESCRIPTION OF THE INVENTION

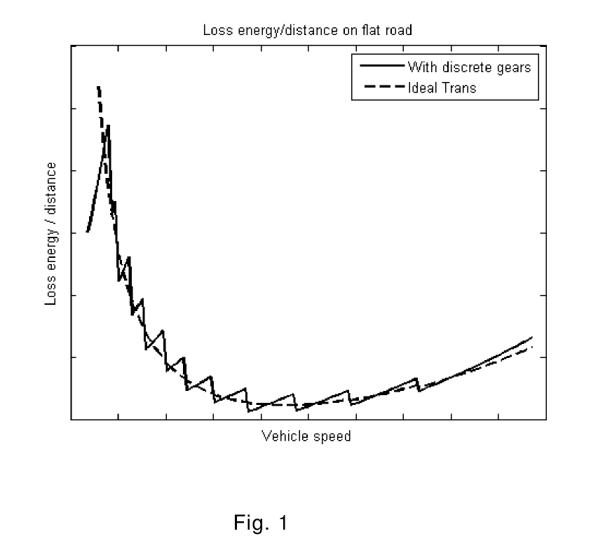

The energy consumption E per travelled kilometer as a function of actual vehicle speed v_actual for an exemplary motor vehicle travelling on a flat road is shown in FIG. 1. Here, the solid line shows the energy consumption E for a gearbox with discrete steps, while the dashed line shows the energy consumption E for an ideal transmission. As can be seen, the total energy consumption E, after an initial increase as the vehicle is set into motion, decreases with vehicle speed. Each gear shift to a higher transmission mode results in a sudden reduction in energy, or fuel, consumption. In this specification, the term “shifting to a higher transmission mode” covers an upshift to a higher gear position for a gearbox, i.e. an upshift to a gear with lower gear ratio (engine speed/drive wheel speed). This assumes a gearbox with discrete steps in gear ratio (a classic manual, an automated manual, a double clutch, or an automatic gearbox).

As the vehicle speed continues to increase, the vehicle reaches a minimum energy consumption per travelled kilometer. Above a certain optimum vehicle speed, the energy consumption starts to increase, mainly due to the increased air resistance as the speed increases. The numeric value of the optimum vehicle speed depends on the configuration and mass of the vehicle. In order to save time and fuel, it is generally advantageous to reduce the speed at relatively high speeds, such as above the optimum vehicle speed, and to increase the speed when driving at relatively low speeds. The threshold speed v_threshold of the vehicle can be set close to the optimum vehicle speed as determined e.g. from an estimation of the total energy consumption of the vehicle.

By a motor vehicle is here intended a vehicle which is powered by an internal combustion engine and/or by an electric motor. In particular, but not exclusively, the method is intended for use in a heavy motor vehicle such as a truck or a bus.

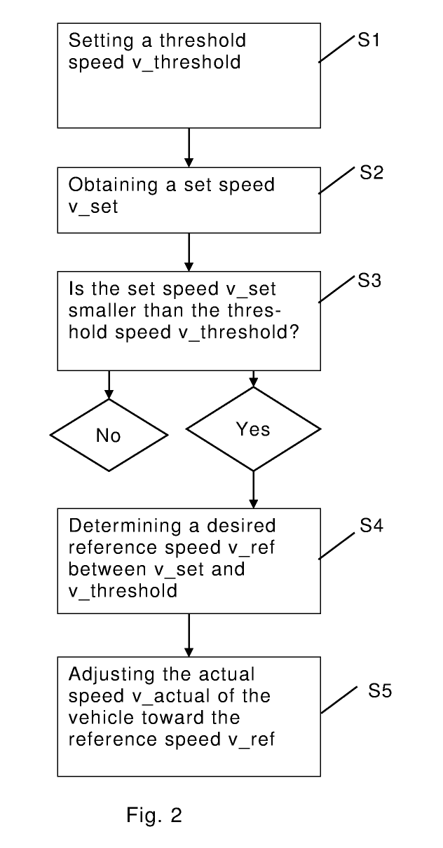

A method according to the invention is schematically shown in FIG. 2. In a first step S1, a threshold speed v_threshold is set. The threshold speed v_threshold is set based on the present vehicle configuration and several parameters may be taken into account, such as vehicle mass and an estimated air resistance of the vehicle, as well as other estimated power losses resulting from auxiliary systems, roll resistance, engine friction, transmission friction, and electrical losses. The threshold speed v_threshold may preferably be determined on the basis of a determined energy consumption E per travelled kilometer of the vehicle as a function of vehicle speed, taking the above mentioned power losses into account. Driver or haulage company preferences, foreseen driving conditions, gear changing schemes or vehicle type, may also be taken into account. For example, it may be desirable to set a low threshold speed v_threshold, since the potential savings in energy consumption E are largest for small speeds. Setting the threshold speed v_threshold to a higher value results in a more offensive driving pattern, since it will result in speed increases also from relatively high set speeds v_set. The threshold speed v_threshold of the vehicle is preferably set independently of any external factors such as legal speed limits.

In a second step S2, the set speed v_set is obtained. This set speed v_set may be the speed requested by a driver of the vehicle, e.g. via a cruise control or via an accelerator pedal. It may also be a speed set by external conditions, based on e.g. a legal speed limit or a central communication and control system controlling the vehicle.

In a third step S3, the set speed v_set is compared to the threshold speed v_threshold. If the set speed v_set is higher than the threshold speed v_threshold, the reference speed v_ref is determined independently of the method according to the present invention. Once the set speed v_set is changed, a new comparison is performed. If on the other hand the set speed v_set is below the threshold speed v_threshold, a desired reference speed v_ref between the set speed v_set and the threshold speed v_threshold is determined in a step S4. An allowed speed range with an upper limit v_max and a lower limit v_min may additionally be defined. In this case, the reference speed v_ref is determined so that it falls within the allowed speed range. The lower limit v_min of this allowed speed range may, but must not necessarily, equal the set speed v_set. The upper limit v_max may e.g. be set to vary with the set speed v_set, or to deviate from the set speed v_set by a fixed value.

The reference speed v_ref can be seen as an output signal from a cruise control of the vehicle, which is used to control the engine, providing control of the vehicle's actual speed. Thus, in a step S5, the actual speed v_actual of the vehicle is adjusted toward the reference speed v_ref, i.e. so that it reaches the reference speed v_ref. This can be achieved either automatically using the cruise control, or manually by the driver. In the latter case, presentation means are used to present the reference speed v_ref to the driver. The reference speed can e.g. be shown on a display, or presented in the form of an audio message.

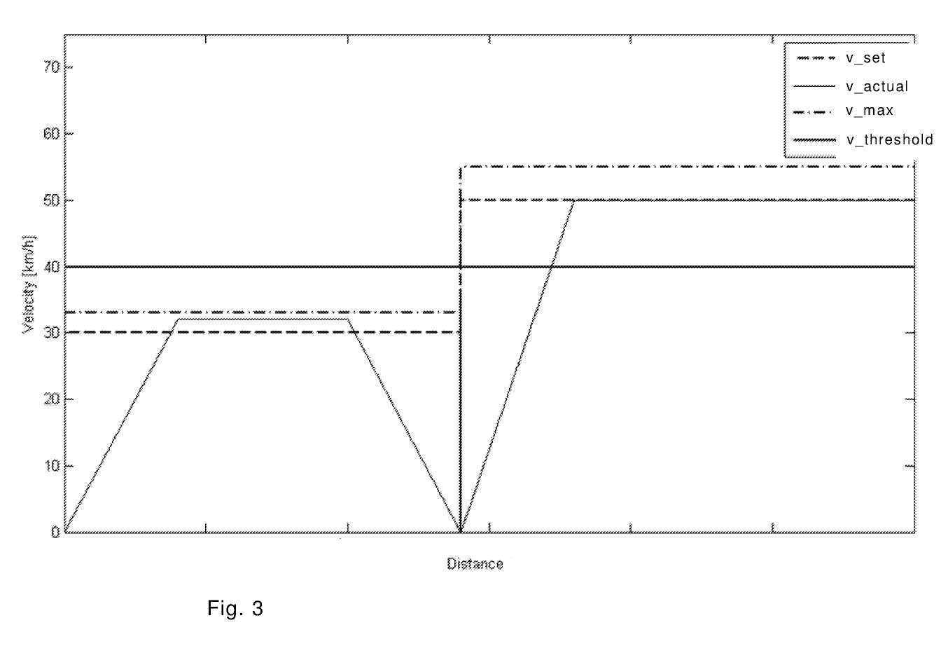

FIG. 3 shows the actual speed v_actual, the set speed v_set, the defined upper limit v_max of an allowed speed range, and the threshold speed v_threshold of an exemplary motor vehicle as a function of distance travelled by the vehicle. The exemplary vehicle here travels on a flat road. For this particular vehicle configuration, the threshold speed v_threshold has been set to 40 km/h. The first set speed v_set is 30 km/h, which the vehicle reaches after a certain distance. The set speed v_set is here determined by external means, such as by reading of road signs or by data transmission to the vehicle, and/or from map-data stored in the vehicle. An allowed speed range with a lower limit v_min (not shown in FIG. 3) and an upper limit v_max is defined. The lower limit v_min here equals the set speed v_set and the upper limit v_max is set to vary with the set speed v_set as v_max=1.1*v_set. Thereby, the allowed speed range has an upper limit v_max of 33 km/h for a set speed v_set of 30 km/h. The actual speed v_actual of the vehicle is adjusted to a reference speed v_ref slightly lower than the allowed upper limit v_max. In FIG. 3, v_ref=v_actual except during the acceleration and deceleration of the vehicle. After driving at the reference speed v_ref for a while, the vehicle is braked and comes to a stop. When taking off again, the set speed v_set has changed to 50 km/h, which is above the threshold speed v_threshold. The upper limit v_max is here 55 km/h, but since the vehicle is travelling at an actual speed v_actual above the threshold speed, the actual speed of the vehicle is not increased above the set speed v_set, since such a speed increase would negatively affect the total energy consumption E of the vehicle.

One skilled in the art will appreciate that a method for controlling the actual speed of a vehicle according to the present invention may be implemented in a computer program which, when executed in a computer, causes the computer to conduct the method. The computer program usually takes the form of a computer program product which comprises a suitable digital storage medium on which the computer program is stored. Said computer-readable digital storage medium comprises a suitable memory, e.g. ROM (read-only memory), PROM (programmable read-only memory), EPROM (erasable PROM), flash memory, EEPROM (electrically erasable PROM), a hard disc unit, etc.

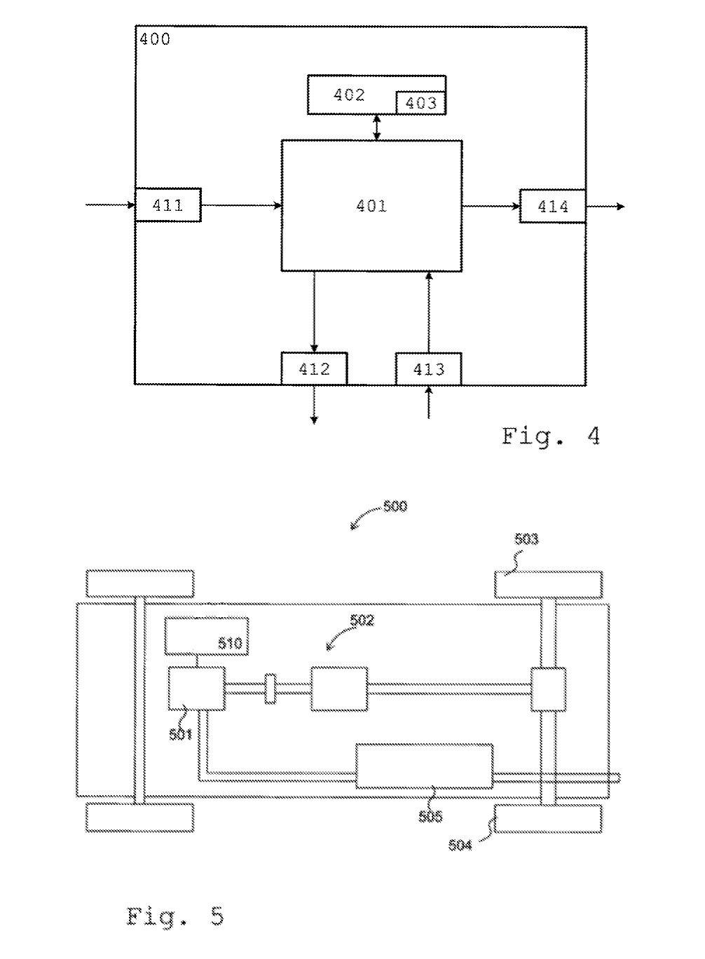

FIG. 4 depicts schematically an electronic control unit 400 of a vehicle provided with an execution means 401 which may take the form of substantially any suitable type of processor or microcomputer, e.g. a circuit for digital signal processing (digital signal processor, DSP), or a circuit with a predetermined specific function (application specific integrated circuit, ASIC). The execution means 401 is connected to a memory unit 402 which is situated in the control unit 400. A data storage medium 403 is also connected to the execution means and provides the execution means with, for example, the stored program code and/or stored data which the execution means needs to enable it to do calculations. The execution means is also adapted to storing partial or final results of calculations in the memory unit 402.

The control unit 400 is further provided with respective devices 411, 412, 413, 414 for receiving and sending input and output signals. These input and output signals may comprise waveforms, pulses or other attributes which the input signal receiving devices 411, 413 can detect as information and which can be converted to signals which the execution means 401 can process. These signals are then supplied to the execution means. The output signal sending devices 412, 414 are arranged to convert signals received from the execution means 401, in order to create, e.g. by modulating them, output signals which can be conveyed to other parts of the vehicle and/or other systems on board.

Each of the connections to the respective devices for receiving and sending input and output signals may take the form of one or more from among a cable, a data bus, e.g. a CAN (controller area network) bus, a MOST (media orientated systems transport) bus or some other bus configuration, or a wireless connection. One skilled in the art will appreciate that the aforesaid computer may take the form of the execution means 401 and that the aforesaid memory may take the form of the memory unit 402.

Control systems in modern vehicles generally comprise a communication bus system consisting of one or more communication buses for connecting together a number of electronic control units (ECUs), or controllers, and various components on board the vehicle. Such a control system may comprise a large number of control units and the responsibility for a specific function may be divided between two or more of them.

In the embodiment depicted, the present invention is implemented in the control unit 400 but might also be implemented wholly or partly in one or more other control units already on board the vehicle or a control unit dedicated to the present invention. Vehicles of the type here concerned are of course often provided with significantly more control units than shown here, as one skilled in the art will surely appreciate.

The present invention according to one aspect relates to a motor vehicle 500 which is schematically shown in FIG. 5. The motor vehicle 500 may e.g. be a passenger car, a truck or a bus, comprising an engine 501, which via a driveline 502 drives driving wheels 503, 504, an exhaust treatment system 505, and a control unit 510, which corresponds to the above-mentioned control unit 400 in FIG. 4, and which is arranged to control the function in the engine 501.

The invention is of course not in any way restricted to the embodiments described above. On the contrary, many possibilities to modifications thereof will be apparent to a person with ordinary skill in the art without departing from the basic idea of the invention such as defined in the appended claims.

1. A method for controlling an actual speed of a motor vehicle, said method comprising the steps of:
based on a vehicle configuration and a vehicle mass of the present vehicle, setting a threshold speed for the vehicle;
obtaining a set speed of the vehicle;
comparing the set speed to the threshold speed;
if the set speed is below the threshold speed, determining a desired reference speed of the vehicle between the set speed and the threshold speed; and
adjusting the actual speed of the vehicle toward the reference speed.

2. The method according to claim 1, wherein an allowed speed range having a lower limit and an upper limit is defined, and wherein the reference speed is determined so that it is a speed defined between the lower and upper limits of the allowed speed range.

3. The method according to claim 1, wherein the reference speed is determined as a function of the set speed.

4. The method according to claim 1, wherein the reference speed is determined in dependence on external conditions.

5. The method according to claim 1, wherein the step of setting the threshold speed comprises determining an energy consumption per travelled selected distance amount of the vehicle as a function of vehicle speed, and based thereon setting the threshold speed.

6. The method according to claim 5, wherein said threshold speed is set so that, at the threshold speed, the determined energy consumption per travelled selected distance amount of the vehicle is within a desired energy consumption range.

7. The method according to claim 5, wherein determining the energy consumption per travelled selected distance amount of the vehicle as a function of vehicle speed comprises determining power losses relating to at least an air resistance of the vehicle.

8. The method according to claim 7, wherein determining the energy consumption per travelled selected distance amount of the vehicle as a function of vehicle speed further comprises determining power losses relating to at least one of roll resistance, friction in a power train of the vehicle, auxiliary systems of the vehicle, and/or an electric motor of the vehicle.

9. The method according to claim 1, wherein the step of setting the threshold speed is carried out at least following a detection of a change in vehicle mass.

10. The method according to claim 1, wherein the step of determining a desired reference speed comprises:
given the actual vehicle speed, determining a lowest possible vehicle speed increase for which a shift to a higher transmission mode of the vehicle is possible; and
based on said determination, setting the reference speed.

11. The method according to claim 10, wherein the reference speed is set to the determined lowest possible speed for which a shift to a higher transmission mode of the vehicle is possible.

12. The method according to claim 1, wherein the step of adjusting the actual speed to the reference speed is conducted automatically using a cruise control of the vehicle.

13. (canceled)

14. A computer program product comprising a non-transitory data storage medium which can be read by a computer and on which program code of a computer program is stored, said program code used for controlling an actual speed of a motor vehicle, said program code comprising computer instructions to cause one or more computer processors to perform the following operations:
based on a vehicle configuration and a vehicle mass of the present vehicle, setting a threshold speed for the vehicle;
obtaining a set speed of the vehicle;
comparing the set speed to the threshold speed;
if the set speed is below the threshold speed, determining a desired reference speed of the vehicle between the set speed and the threshold speed; and
adjusting the actual speed of the vehicle toward the reference speed.

15. An electronic control unit of a motor vehicle comprising:
an execution means;
a memory connected to the execution means; and
a data storage medium which is connected to the execution means and on which program code of a computer program is stored, said program code used for controlling an actual speed of a motor vehicle, said program code comprising computer instructions to cause one or more computer processors to perform the following operations:
based on a vehicle configuration and a vehicle mass of the present vehicle, setting a threshold speed for the vehicle;
obtaining a set speed of the vehicle;
comparing the set speed to the threshold speed;
if the set speed is below the threshold speed, determining a desired reference speed of the vehicle between the set speed and the threshold speed; and
adjusting the actual speed of the vehicle toward the reference speed.

16. A motor vehicle comprising an electronic control unit, said electronic control unit comprising:
an execution means;
a memory connected to the execution means; and
a data storage medium which is connected to the execution means and on which program code of a computer program is stored, said program code used for controlling an actual speed of a motor vehicle, said program code comprising computer instructions to cause one or more computer processors to perform the following operations:
based on a vehicle configuration and a vehicle mass of the present vehicle, setting a threshold speed for the vehicle;
obtaining a set speed of the vehicle;
comparing the set speed to the threshold speed;
if the set speed is below the threshold speed, determining a desired reference speed of the vehicle between the set speed and the threshold speed; and
adjusting the actual speed of the vehicle toward the reference speed.

17. A motor vehicle according to claim 16, wherein the motor vehicle is a truck or a bus.

18. The method according to claim 1, wherein the selected distance amount is a kilometer, and wherein the step of setting the threshold speed comprises determining an energy consumption per travelled kilometer-of the vehicle as a function of vehicle speed, and based thereon setting the threshold speed.
